(19) United States
(12) Patent Application Publication
(10) Pub. No.: US 2025/0319541 A1
(43) Pub. Date: Oct. 16, 2025

(54) REMOTE MONITORING SYSTEM, REMOTE MONITORING METHOD, DATA PROCESSING APPARATUS, DATA PROCESSING METHOD, TERMINAL APPARATUS, METHOD FOR CONTROLLING TERMINAL APPARATUS, AND PROGRAM

(71) Applicant: Kabushiki Kaisha Kobe Seiko Sho (Kobe Steel, Ltd.), Kobe-shi (JP)

(72) Inventors: Keito ISHIZAKI, Fujisawa-shi (JP); Kazuki HIDAKA, Fujisawa-shi (JP); Takeshi YANO, Fujisawa-shi (JP)

(73) Assignee: Kabushiki Kaisha Kobe Seiko Sho (Kobe Steel, Ltd.), Kobe-shi (JP)

(21) Appl. No.: 19/050,335

(22) Filed: Feb. 11, 2025

(30) Foreign Application Priority Data
Apr. 12, 2024 (JP) 2024-064682

(51) Int. Cl. B23K 9/095; B23K 9/10; B23K 31/12; G06F 3/04847

(52) U.S. Cl. CPC B23K 9/0956; B23K 9/0953; B23K 9/1006; B23K 31/125; G06F 3/04847

(57) ABSTRACT

A remote monitoring system includes a robot, an image capturing device that captures image data of an operating area of the robot, a power supply, a data processing apparatus that processes data for the robot or the power supply, and a terminal apparatus that communicates with the data processing apparatus via a network. The data processing apparatus includes a generation unit that generates streaming data using the image data, a distribution unit that distributes the streaming data, and a robot command unit that issues at least one of an operation instruction to the robot or an operation instruction to the power supply. The terminal apparatus includes a display control unit that receives and displays the streaming data on a monitoring screen, and an instruction receiving unit that receives an instruction for the robot or the power supply on the monitoring screen and transmits the instruction to the data processing apparatus.

### BACKGROUND OF THE INVENTION

### 1. Field of the Invention

The present invention relates to a remote monitoring system, a remote monitoring method, a data processing apparatus, a data processing method, a terminal apparatus, a method for controlling the terminal apparatus, and a program.

### 2. Description of the Related Art

In recent years, visual sensors have been adopted in production sites of various industries, and remote monitoring has been carried out using image data obtained by the visual sensors. Such remote monitoring allows a worker to grasp the state of their production site while performing other work, or to check the production status in a place where people cannot enter, and is therefore used to improve the work efficiency of the worker.

One example of a field in which remote monitoring is used is the welding field, and, for example, as described in Japanese Unexamined Patent Application Publication No. 2019-505391, there is a technique for monitoring the welding status. Japanese Unexamined Patent Application Publication No. 2019-505391 discloses a configuration for providing a welder with feedback on welding work to allow the welder to perform the welding work as if the welder were in the same location as a welding robot. As a result, the configuration disclosed in Japanese Unexamined Patent Application Publication No. 2019-505391 makes it possible to remotely perform various types of welding work.

The method disclosed in Japanese Unexamined Patent Application Publication No. 2019-505391 is a technique for performing various types of welding work remotely. However, no consideration is given to what specific information can be monitored and to what extent. In welding work, a large amount of information is to be monitored, and the greater the amount of information, the more likely it is that the information that can be monitored on the terminal will be delayed. Accordingly, the difficulty of real-time monitoring remains an issue. Furthermore, remote control based on the status of a monitoring target is also not taken into consideration. In view of further improvement in work efficiency, a function that allows easy remote control according to the status of the monitoring target is desired.

### SUMMARY OF THE INVENTION

Accordingly, it is an object of the present invention to reduce delays in the acquisition and presentation of monitoring information by a terminal apparatus and to enable easy remote control according to the status of a monitoring target.

To address the issues described above, an aspect of the present invention has the following configuration. A remote monitoring system includes a robot, an image capturing device configured to perform image capture of an operating area of the robot, a power supply configured to control an output of a current or a voltage, a data processing apparatus configured to process data related to an operation of the robot or the power supply, and a terminal apparatus configured to communicate with the data processing apparatus via a network. The data processing apparatus includes a generation unit configured to generate streaming data by using image data captured by the image capturing device, a distribution unit configured to distribute the streaming data, and a robot command unit configured to issue at least one of an operation instruction to the robot or an operation instruction to the power supply in accordance with at least an instruction from the terminal apparatus. The terminal apparatus includes a display control unit configured to receive the streaming data distributed from the data processing apparatus and display the streaming data on a monitoring screen, and an instruction receiving unit configured to receive an instruction for the robot or the power supply on the monitoring screen and transmit the instruction to the data processing apparatus.

Another aspect of the present invention has the following configuration. A remote monitoring method for a system, the system including a robot, an image capturing device that performs image capture of an operating area of the robot, a power supply that controls an output of a current or a voltage, a data processing apparatus that processes data related to an operation of the robot or the power supply, and a terminal apparatus that communicates with the data processing apparatus via a network includes a generation step of, by the data processing apparatus, generating streaming data by using image data captured by the image capturing device; a distribution step of, by the data processing apparatus, distributing the streaming data; a robot command step of, by the data processing apparatus, issuing at least one of an operation instruction to the robot or an operation instruction to the power supply in accordance with at least an instruction from the terminal apparatus; a display control step of, by the terminal apparatus, receiving the streaming data distributed from the data processing apparatus and displaying the streaming data on a monitoring screen; and an instruction receiving step of, by the terminal apparatus, receiving an instruction for the robot or the power supply on the monitoring screen and transmitting the instruction to the data processing apparatus.

Another aspect of the present invention has the following configuration. A data processing apparatus for processing data related to an operation of a robot or a power supply includes a generation unit configured to generate streaming data by using image data of an operating area of the robot, the image data being captured by an image capturing device, a distribution unit configured to distribute the streaming data to a terminal apparatus via a network, and a robot command unit configured to issue at least one of an operation instruction to the robot or an operation instruction to the power supply in accordance with at least an instruction received from the terminal apparatus via the network.

Another aspect of the present invention has the following configuration. A terminal apparatus for communicating via a network with a power supply or a data processing apparatus that processes data related to an operation of a robot, includes a display control unit configured to receive streaming data distributed from the data processing apparatus and display the streaming data on a monitoring screen, and an instruction receiving unit configured to receive an instruction for the robot or the power supply on the monitoring screen and transmit the instruction to the data processing apparatus.

Another aspect of the present invention has the following configuration. A data processing method for processing data related to an operation of a robot includes a generation step of generating streaming data by using image data of an operating area of the robot, the image data being captured by an image capturing device; a distribution step of distributing the streaming data to a terminal apparatus via a network; and a robot command step of issuing at least one of an operation instruction to the robot or an operation instruction to a power supply in accordance with at least an instruction received from the terminal apparatus via the network.

Another aspect of the present invention has the following configuration. A method for controlling a terminal apparatus that communicates via a network with a power supply or a data processing apparatus that processes data related to an operation of a robot includes a display control step of receiving streaming data distributed from the data processing apparatus and displaying the streaming data on a monitoring screen; and an instruction receiving step of receiving an instruction for the robot or the power supply on the monitoring screen and transmitting the instruction to the data processing apparatus.

Another aspect of the present invention has the following configuration. A program causes a computer to implement a generation unit configured to generate streaming data by using image data of an operating area of a robot, the image data being captured by an image capturing device; a distribution unit configured to distribute the streaming data to a terminal apparatus via a network; and a robot command unit configured to issue at least one of an operation instruction to the robot or an operation instruction to a power supply in accordance with at least an instruction received from the terminal apparatus via the network.

Another aspect of the present invention has the following configuration. A program causes a computer that communicates via a network with a power supply or a data processing apparatus that processes data related to an operation of a robot to implement a display control unit configured to receive streaming data distributed from the data processing apparatus and display the streaming data on a monitoring screen; and an instruction receiving unit configured to receive an instruction for the robot or the power supply on the monitoring screen and transmit the instruction to the data processing apparatus.

An aspect of the present invention makes it possible to reduce delays in the acquisition and presentation of monitoring information by a terminal apparatus, and enables easy remote control according to the status of a monitoring target.

### BRIEF DESCRIPTION OF THE DRAWINGS

FIG. 1 is a schematic diagram illustrating an example configuration of a welding system according to an embodiment of the present invention;

FIG. 2 is a block diagram illustrating an example functional configuration of the welding system according to an embodiment of the present invention;

FIG. 3 is a flowchart of a monitoring process performed on an information processing apparatus according to an embodiment of the present invention;

FIG. 4 is a flowchart of a monitoring process performed on a terminal apparatus according to an embodiment of the present invention;

FIG. 5 is a schematic diagram illustrating an example configuration of a user interface (UI) screen of a terminal apparatus according to an embodiment of the present invention;

FIG. 6A is a schematic diagram illustrating an example configuration of a UI screen of the terminal apparatus according to an embodiment of the present invention;

FIG. 6B is a schematic diagram illustrating an example configuration of a UI screen of the terminal apparatus according to an embodiment of the present invention;

FIG. 6C is a schematic diagram illustrating an example configuration of a UI screen of the terminal apparatus according to an embodiment of the present invention;

FIG. 6D is a schematic diagram illustrating an example configuration of a UI screen of the terminal apparatus according to an embodiment of the present invention;

FIG. 6E is a schematic diagram illustrating an example configuration of a UI screen of the terminal apparatus according to an embodiment of the present invention; and

FIG. 6F is a schematic diagram illustrating an example configuration of a UI screen of the terminal apparatus according to an embodiment of the present invention.

### DESCRIPTION OF THE PREFERRED EMBODIMENTS

Embodiments of the present invention will be described hereinafter with reference to the drawings and the like. The following embodiments are embodiments for describing the present invention and are not intended to be interpreted as limiting the present invention. In addition, all the configurations described in each embodiment are not necessarily essential to achieve the advantages of the present invention. In the drawings, the same components are denoted by the same reference numerals to indicate the correspondence.

### First Embodiment

An embodiment of the present invention will be described hereinafter with reference to the drawings. The present embodiment describes an example of a welding system capable of remote monitoring and remote control and including a welding robot. However, a remote monitoring method according to the present embodiment is not limited to a configuration applied to the welding robot, and can be widely applied to devices that use robots, such as a slag removal device, a cutting device, a gouging device, a non-destructive inspection device, an object gripping device, and a transport device. In addition, the configuration of the welding system described below is an example and is not limited to this.

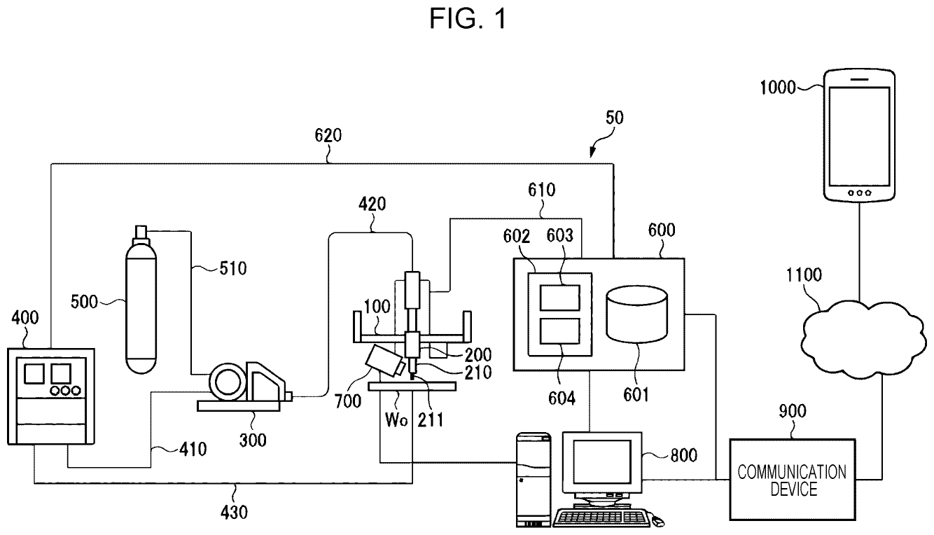

FIG. 1 is a schematic diagram illustrating an example configuration of a welding system according to the present embodiment. As illustrated in FIG. 1, a welding system 50 includes a welding robot 100, a feeding device 300, a welding power supply 400, a shielding gas supply source 500, a robot control device 600, an image capturing device 700, a data processing apparatus 800, and a communication device 900. In a case where the features of the present embodiment are applied to a six-axis welding robot, the welding system 50 may include additional components in accordance with the configuration of the six-axis welding robot. The components of the welding system 50 are communicably connected to each other by various wired or wireless communication methods. The connection may be performed using not a single communication method but a combination of multiple communication methods.

The welding system 50 is configured to be capable of communicating with a terminal apparatus 1000 via a network 1100. The welding system 50 and the terminal apparatus 1000 may be installed at different locations in the same site, or may be installed in different sites.

### Robot Control Device

The robot control device 600 is connected to the welding robot 100, which is of a portable type, via a robot control cable 610 and is connected to the welding power supply 400 via a power supply control cable 620. The robot control device 600 includes a data holding unit 601. The data holding unit 601 holds teaching data that specifies in advance an operation pattern, a welding start position, a welding end position, construction conditions, welding conditions, and the like of the welding robot 100. The robot control device 600 sends command information as a command to the welding robot 100 and the welding power supply 400 based on the teaching data, and controls the operations and welding conditions of the welding robot 100 and the welding power supply 400.

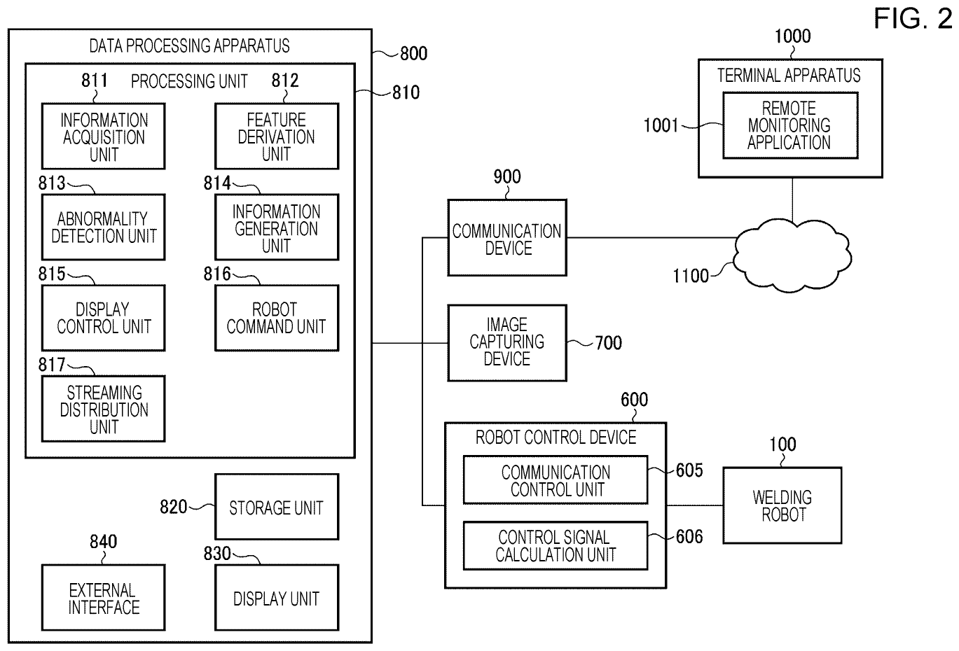

The robot control device 600 further includes a control unit 602. The control unit 602 includes, for example, a groove shape information calculation unit 603, a welding condition acquisition unit 604, a communication control unit 605, and a control signal calculation unit 606. The groove shape information calculation unit 603 calculates groove shape information from detection data obtained by performing sensing such as touch sensing on the groove shape before welding. The welding condition acquisition unit 604 corrects and acquires the welding conditions in the teaching data based on the groove shape information. The communication control unit 605 and the control signal calculation unit 606 will be described below with reference to FIG. 2.

After welding is started under the welding conditions in the teaching data corrected through sensing, the data processing apparatus 800 extracts feature information (hereinafter also referred to as a feature) based on image data acquired from the image capturing device 700 during welding. Then, the robot control device 600 receives correction signals for various processes as command information from the feature. The feature is not limited. In the present embodiment, coordinate data of feature points indicated in the image data will be described as an example of the feature. The robot control device 600 sequentially performs control of, for example, gap processing, electrode manipulation processing, tracking/weaving processing, and speed processing. As described above, the robot control device 600 performs each control process in accordance with a correction signal received during welding, and thereafter outputs status update information of various control conditions to the welding robot 100, the welding power supply 400, the terminal apparatus 1000, the data processing apparatus 800, and the like. The robot control device 600 repeats the processing until welding as intended is completed. A control signal based on the feature extracted from the image data may be generated on the data processing apparatus 800 side, or may be generated on the robot control device 600 side. Alternatively, one of the data processing apparatus 800 and the robot control device 600 may generate the control signal, and the other may correct the generated control signal.

The robot control device 600 illustrated in FIG. 1 further includes a controller (hereinafter also referred to as a “teaching pendant”) for performing teaching, a manual operation of the welding robot 100, and the like, and a controller having other control functions. These controllers may be integrally formed. From the viewpoint of usability at a welding site, it is preferable to provide two separate controllers: a controller for performing teaching, a manual operation of the welding robot 100, which is of a portable type, and the like, and a controller having other control functions. In the present embodiment, furthermore, signals are sent using the robot control cable 610 and the power supply control cable 620. However, this is not limiting. Signals may be wirelessly transmitted.

In the present embodiment, the terminal apparatus 1000 used for remote monitoring also functions as a controller. As example operations will be described below, an operator of the terminal apparatus 1000 gives a desired instruction while referring to moving image data (hereinafter also referred to as “streaming data”) distributed by the data processing apparatus 800. The robot control device 600 receives an instruction given from the terminal apparatus 1000 directly or via the data processing apparatus 800, and issues a command to, for example, the welding robot 100 or the welding power supply 400 in accordance with the instruction to perform control related to welding.

While FIG. 1 illustrates one welding robot 100 as a monitoring target, the monitoring target is not limited thereto. For example, multiple image capturing devices 700 may capture images of the respective welding statuses of multiple welding robots 100, and the welding statuses of the multiple welding robots 100 may be monitored by one data processing apparatus 800 or one terminal apparatus 1000. In this case, the terminal apparatus 1000 may switch the streaming data to be displayed on a remote monitoring screen in response to a user operation.

### Welding Power Supply

The welding power supply 400 is a power supply for supplying a current or a voltage related to a welding operation. In response to a command from the robot control device 600, the welding power supply 400 supplies electric power to a welding wire 211, which is a consumable electrode, and a workpiece Wo, thereby generating an arc between the welding wire 211 and the workpiece Wo. The electric power from the welding power supply 400 is delivered to the feeding device 300 via a power cable 410, and is then delivered from the feeding device 300 to a welding torch (hereinafter referred to as a “torch”) 200 via a conduit tube 420. Then, the electric power from the welding power supply 400 is supplied to the welding wire 211 via a contact tip at the tip of the torch 200. The current used during welding work may be either a direct current or an alternating current, and the waveform thereof is not limited. Thus, the current may be a pulse such as a rectangular or triangular wave pulse.

In the welding power supply 400, for example, the power cable 410 is connected to the torch 200 as a positive electrode, and a power cable 430 is connected to the workpiece Wo as a negative electrode. The above is a case where welding is performed with reverse polarity. In a case where welding is performed with positive polarity, the power cable serving as the positive electrode is connected to the workpiece Wo, and the power cable serving as the negative electrode is connected to the torch 200.

### Shielding Gas Supply Source

The shielding gas supply source 500 includes a container filled with a shielding gas, and an associated member such as a valve. The shielding gas is delivered from the shielding gas supply source 500 to the feeding device 300 via a gas tube 510. The shielding gas delivered to the feeding device 300 is fed to the torch 200 via the conduit tube 420. The shielding gas fed to the torch 200 flows inside the torch 200, and is guided by a nozzle 210 and ejected from the tip of the torch 200. Examples of the shielding gas that can be used include argon (Ar), carbon dioxide (CO₂), and a mixture thereof.

The conduit tube 420 has a conductive path formed on the outer sheath side thereof to function as a power cable, and a protective tube arranged thereinside to protect the welding wire 211. Accordingly, a flow path for the shielding gas is formed in the conduit tube 420. However, the conduit tube 420 is not limited to this configuration. For example, a cable for supplying electric power and a hose for supplying the shielding gas may be bundled around a protective tube for feeding the welding wire 211 to the torch 200. Alternatively, for example, a tube for feeding the welding wire 211 and the shielding gas and a power cable may be separately installed.

### Feeding Device

The feeding device 300 feeds the welding wire 211 to the torch 200. The welding wire 211 fed by the feeding device 300 is not limited, and is selected depending on the properties of the workpiece Wo, the welding form, and the like. For example, a solid wire or a flux-cored wire is used as the welding wire 211. The diameter of the welding wire 211 is not limited.

The conduit tube 420 has a conductive path formed on the outer sheath side thereof to function as a power cable, and a protective tube arranged thereinside to protect the welding wire 211. Accordingly, a flow path for the shielding gas is formed in the conduit tube 420. However, the conduit tube 420 is not limited to this configuration. For example, a cable for supplying electric power and a hose for supplying the shielding gas may be bundled around a protective tube for feeding the welding wire 211 to the torch 200. Alternatively, for example, a tube for feeding the welding wire 211 and the shielding gas and a power cable may be separately installed.

Further, a touch sensor is used as a detection means. Specifically, a voltage is applied between the workpiece Wo and the welding wire 211, and a voltage drop phenomenon occurs when the welding wire 211 comes into contact with the workpiece Wo. The touch sensor utilizes the voltage drop phenomenon to sense the surface or the like of a groove. The detection means is not limited to a touch sensor, and may be an image sensor, a laser sensor, or the like, or a combination of these detection means. Preferably, the detection means is a touch sensor in view of its simple device configuration.

### Image Capturing Device

The image capturing device 700 (hereinafter also referred to as a “camera”) is constituted by, for example, a camera including a complementary metal oxide semiconductor (CMOS) sensor as a visual sensor. The image capturing device 700 may be installed at any location. The image capturing device 700 may be directly attached to the welding robot 100, or may be fixed at a specific location around the welding robot 100 as a monitoring camera. In a case where the image capturing device 700 is directly attached to the welding robot 100, the image capturing device 700 moves in accordance with the operation of the welding robot 100 so as to capture an image of an environment around the tip of the torch 200. The image capturing device 700 may include multiple cameras. For example, the image capturing device 700 may be configured using multiple cameras having different functions and installed at different locations.

In addition, the image capturing device 700 may capture an image in any direction. For example, in a case where a direction in which welding progresses is set as the forward direction, the image capturing device 700 may be installed so as to capture an image of the front side of an object (target) to be included in the image data, or may be installed so as to capture an image of the side surface side or the rear side of the object (target). Accordingly, the imaging range of the image capturing device 700 may be determined appropriately. It is preferable to capture images from the front side of the object (target) to reduce interference with the torch 200. In the present embodiment, images are captured from the front side of the object (target). Captured image information is transmitted to the data processing apparatus 800 and used on the data processing apparatus 800 side. At this time, the data processing apparatus 800 may capture any image from the captured image information at a predetermined interval, for example, and use the image for processing described below. The method and setting for capturing the image may be switched according to, for example, the configuration and functions of the image capturing device 700, the performance of the data processing apparatus 800, and the like.

In the present embodiment, the image capturing device 700 is directly attached and fixed to the welding robot 100, and is used to capture a moving image such that at least the workpiece Wo, the welding wire 211, and the arc are included in the imaging range as objects (targets) to be included in the image data. The various settings for capturing the image may be defined in advance, or may be switched according to the operating conditions of the welding system 50. Examples of the settings for capturing the image include the frame rate, the number of pixels of the image, the resolution, and the shutter speed.

The data processing apparatus 800 is an information processing apparatus including, for example, a computer. The computer includes a processing unit 810 and a storage unit 820, which will be described below. The processing unit 810 is constituted by, for example, a central processing unit (CPU). The storage unit 820 is constituted by, for example, a volatile or nonvolatile memory such as a hard disk drive (HDD), a read only memory (ROM), or a random access memory (RAM). The processing unit 810 executes computer programs stored in the storage unit 820 for implementing various functions described below to transmit various commands to the robot control device 600 and execute a monitoring process described below.

### Communication Device

The communication device 900 includes an antenna (not illustrated). The communication device 900 is connected to the data processing apparatus 800 and the robot control device 600, and communicates with an external device via the network 1100. Examples of the external device include the terminal apparatus 1000. The communication method or communication standard of the network 1100 is not limited as long as the network 1100 is configured to enable data transmission and reception between the communication device 900 and the terminal apparatus 1000.

### Terminal Apparatus

The terminal apparatus 1000 may be, for example, a tablet terminal, a mobile personal computer (PC), a point-of-sale (POS) terminal, a dedicated terminal, a smart watch, or smart glasses. The terminal apparatus 1000 executes a monitoring process described below, receives an instruction from a user, and provides various types of information to the user.

### Trained Model

Feature points to be extracted from image data and a trained model for extracting the feature points in the present embodiment will be described. The trained model used in the present embodiment is composed of a convolutional neural network, and includes multiple convolution layers and multiple pooling layers. The configuration of the convolutional neural network is not limited to that described above, and the number of layers and the configuration may be different. Thus, a known method may be used for a learning process, and a trained model that is available in the monitoring described below may be used as appropriate.

In the present embodiment, the term “learning” or “machine learning” refers to generating a “trained model” by performing learning using training data and any learning algorithm. The trained model is updated at any time as learning progresses using multiple pieces of training data, and the output changes even for the same input. Thus, the trained model is not limited to a state at a certain point in time. Here, a model used in learning is referred to as a “learning model”, and a learning model that has undergone a certain degree of learning is referred to as a “trained model”. Furthermore, the configuration of the “training data” may be changed according to the learning algorithm used. The training data may include labeled data used for learning itself, validation data used to validate the trained model, and test data used to test the trained model. In the following description, “training data” is used as a general term for learning-related data, and “labeled data” is used as data used for performing learning itself. Note that the labeled data, the validation data, and the test data included in the training data are not intended to be classified clearly. For example, depending on the training, validation, and testing methods, all the pieces of training data may be labeled data.

The trained model receives, as an input, image data output from the image capturing device 700, and outputs the feature related to various types of welding information that appear in the image data. In the present embodiment, the image data to be input to the trained model includes at least a molten pool, a welding wire, and an arc as objects (targets), and feature points obtained from the respective objects or from multiple objects of these objects are extracted as coordinate data. Then, based on the coordinate data of the extracted feature points, the data processing apparatus 800 calculates an amount of tracking correction and amounts of correction for the weaving width, the welding speed, the electrode trajectory (angle), and the like, and transmits information on the obtained correction amounts to the robot control device 600. The image data may also be hereinafter referred to as a welding image.

It is assumed that the trained model has already been generated before a remote monitoring function according to the present embodiment is implemented, and has become available. It is also assumed that the trained model is updated as necessary by the data processing apparatus 800 or an external learning device and is appropriately referred to when used by the data processing apparatus 800.

The present embodiment describes a trained model capable of extracting coordinate data of feature points, by way of example but not limitation. For example, a trained model that detects a predetermined area of the welding image, such as the range of the molten pool or the torch, may be used. In the present embodiment, the feature in image data captured by the image capturing device 700 is identified, and the image data and information based on the feature are combined to generate streaming data. Functional Configuration

FIG. 2 is a block diagram illustrating the system configuration illustrated in FIG. 1, focusing on configurations related to the remote monitoring function according to the present embodiment. The configurations illustrated in FIG. 2 are also an example, and other components and devices may be further included. Moreover, for each of the configurations illustrated in FIG. 2, one component may be divided into multiple portions, or multiple components may be integrated into one.

The data processing apparatus 800 includes the processing unit 810, the storage unit 820, a display unit 830, and an external interface 840. The display unit 830 may be a touch panel display, an organic electro-luminescence (EL) display, or the like. The external interface 840 is a component that handles communication with external devices, and is communicably connected to, for example, the robot control device 600, the image capturing device 700, the communication device 900, and the like.

The processing unit 810 of the data processing apparatus 800 provides the functions of an information acquisition unit 811, a feature derivation unit 812, an abnormality detection unit 813, an information generation unit 814, a display control unit 815, a robot command unit 816, and a streaming distribution unit 817. The functions associated with these components may be implemented by the processing unit 810 reading and executing programs and data stored in the storage unit 820.

The information acquisition unit 811 acquires various types of information from devices such as the robot control device 600, the image capturing device 700, and the communication device 900. The information to be acquired may include image data, command information, detection data, and the like. The feature derivation unit 812 applies the trained model described above to the image data to extract the feature (in this example, coordinate data of feature points) in the image data. The feature derivation unit 812 may update the available trained model as appropriate. The trained model may be configured to be appropriately acquired from a learning device (not illustrated) that performs the learning process, or the data processing apparatus 800 itself may execute the learning process to update the trained model.

The abnormality detection unit 813 detects an abnormality related to welding, based on, for example, the feature derived by the feature derivation unit 812, detection data detected by sensors (not illustrated), and the like. Upon detecting an abnormality, the abnormality detection unit 813 executes a corresponding process based on the detected abnormality. Specifically, the abnormality detection unit 813 displays the detected abnormality on a user interface (UI) screen described below, or notifies various components of the abnormality.

The information generation unit 814 generates streaming data and information to be displayed on the terminal apparatus 1000 or the display unit 830 using the image data captured by the image capturing device 700, the feature derived by the feature derivation unit 812, information on the abnormality detected by the abnormality detection unit 813, and the like. For example, the information generation unit 814 combines the image data captured by the image capturing device 700 and the feature points derived from the image data to generate composite image data. The information generation unit 814 may combine information calculated by the control signal calculation unit 606 of the robot control device 600 using the image data captured by the image capturing device 700 and the coordinate data of the feature points derived from the image data to generate composite image data.

The display control unit 815 causes the display unit 830 to display the information generated by the information generation unit 814, the image data captured by the image capturing device 700, and the like. The robot command unit 816 issues an operation instruction to the welding robot 100 or an instruction to the welding power supply 400 via the robot control device 600 in accordance with an instruction from the terminal apparatus 1000. The robot command unit 816 may generate a command for the robot control device 600, based on the feature derived by the feature derivation unit 812, the information on the abnormality detected by the abnormality detection unit 813, an instruction received from the terminal apparatus 1000, and the like, and provide the command. The robot command unit 816 may transmit the control result of the welding robot 100 by the robot control device 600 to the terminal apparatus 1000 via the communication device 900.

The streaming distribution unit 817 generates streaming data based on the image data generated by the information generation unit 814, and distributes the streaming data. In response to a request or the like from the terminal apparatus 1000, the image data captured by the image capturing device 700 may directly be distributed as streaming data. Further, the streaming distribution unit 817 receives settings for streaming distribution from the operator or the like of the data processing apparatus 800 or the terminal apparatus 1000, and performs distribution control based on the settings. The settings include, for example, the data size and the frame rate. Using streaming distribution of data can reduce storage usage on the terminal apparatus 1000 compared to downloading the data. In addition, real-time playback of the moving image on the terminal apparatus 1000 can be ensured.

In the robot control device 600, the communication control unit 605 controls, for example, communication with the data processing apparatus 800 and communication with the terminal apparatus 1000 via the communication device 900. The control signal calculation unit 606 acquires command information from the data processing apparatus 800 or the terminal apparatus 1000 via the communication control unit 605, and generates a control signal for the welding robot 100 or the welding power supply 400 in accordance with the command information. The control signal calculation unit 606 outputs the generated control signal to at least one of the welding robot 100 or the welding power supply 400. Further, the control signal calculation unit 606 acquires the control result of the welding robot 100, a feedback signal from the welding robot 100, and the like, and provides the acquired data to the data processing apparatus 800 and the terminal apparatus 1000.

The terminal apparatus 1000 includes a remote monitoring application 1001 that receives information from the data processing apparatus 800 or the robot control device 600 and displays a UI screen described below. Examples of the information to be received by the remote monitoring application 1001 include streaming data and information related to welding, such as a current value and a voltage. The remote monitoring application 1001 arranges and displays the acquired information as display items on the UI screen. Further, the remote monitoring application 1001 receives an instruction from the user via the UI screen, and transmits a control instruction based on the instruction to the data processing apparatus 800 or the robot control device 600. The remote monitoring application 1001 may be implemented by a processing unit (not illustrated) included in the terminal apparatus 1000 reading and executing programs and various data stored in a storage unit (not illustrated).

In addition, the data linkage between the functions illustrated in FIG. 2 is an example and is not limited to this. For example, the terminal apparatus 1000 may be configured to directly transmit and receive data to and from the robot control device 600 without the intervention of the data processing apparatus 800. Furthermore, the content of the data to be transmitted and received by each of the robot control device 600, the data processing apparatus 800, and the terminal apparatus 1000 may be defined in advance. For example, among the pieces of information to be displayed on the terminal apparatus 1000, information detected by the robot control device 600 may be directly transmitted from the robot control device 600 to the terminal apparatus 1000. Further, there may be a data type in which an instruction or the like input by the terminal apparatus 1000 is directly transmitted to the robot control device 600.

### Process Flow

### Remote Monitoring Process in Data Processing Apparatus

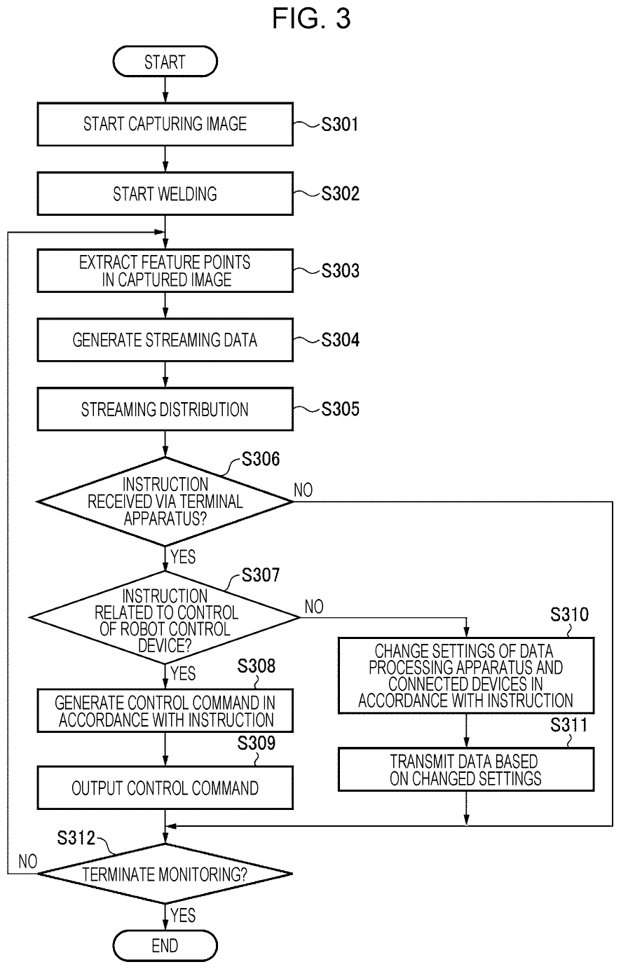

FIG. 3 is a flowchart of a remote monitoring process performed by the data processing apparatus 800 according to the present embodiment. The illustrated process flow may be performed by the processing unit 810 of the data processing apparatus 800 reading and executing a program stored in the storage unit 820 to implement the functions illustrated in FIG. 2. For ease of description, the process flow will be described as being collectively performed by the data processing apparatus 800. The data processing apparatus 800 is capable of transmitting and receiving data in cooperation with various apparatuses such as the welding system 50 and the terminal apparatus 1000.

In S301, the data processing apparatus 800 causes the image capturing device 700 to start capturing an image of the workpiece Wo, the torch 200, and their surroundings. Image-capturing parameters of the image capturing device 700 at the start of capturing an image may be defined in advance. In a case where multiple image capturing devices 700 are provided, each of the image capturing devices 700 is caused to start capturing an image. The captured image may be a still image captured at a predetermined time interval, or may be a moving image captured at a predetermined frame rate.

In S302, the robot control device 600 performs control to start welding. During welding, the image capturing device 700 sequentially captures images to acquire image data, and provides the image data to the data processing apparatus 800.

In S303, the data processing apparatus 800 extracts feature points in the captured image data. In the present embodiment, feature points are extracted using a trained model obtained by the learning process described above. Specifically, a trained model that receives a welding image as an input and outputs coordinate data of feature points such as events of interest included in the welding image is used. The feature points serving as events of interest include, for example, the position of the tip of a molten pool, the width of the molten pool, the position of the tip of a welding torch, and the position of the center of an arc. These feature points are output as coordinate data.

In S304, the data processing apparatus 800 combines the captured image data and the coordinate positions of the feature points obtained from the image data to generate composite image data from which streaming data is generated. The information used to generate the composite image data is not limited to the feature points obtained as the output of the trained model, and may include other information derived from the feature points. For example, an abnormality determination may be performed based on the feature points, and the result of the abnormality determination may be combined with the image data.

In S305, the data processing apparatus 800 sequentially performs streaming distribution of the streaming data (hereinafter also referred to as “video data”) generated in S304. In this example, the destination to which the video data is streamed is the terminal apparatus 1000. Simultaneously and in parallel with the streaming distribution of the video data, various parameters related to welding and detection results from the sensors may be transmitted from the data processing apparatus 800, the robot control device 600, the welding power supply 400, and the like to the terminal apparatus 1000. The detection results include, for example, a welding current and an arc voltage. These detection results are transmitted to the terminal apparatus 1000 and displayed on the terminal apparatus 1000. In the present embodiment, the robot control device 600 acquires detection values of the welding current and the arc voltage from a detector (not illustrated) at any time, and the acquired detection values are transmitted from the robot control device 600 to the terminal apparatus 1000 and are displayed on the terminal apparatus 1000. The same display content as that of the terminal apparatus 1000 may be displayed on the display unit 830 of the data processing apparatus 800.

In S306, the data processing apparatus 800 determines whether an instruction is received via the terminal apparatus 1000. If an instruction is received (YES in S306), the process of the data processing apparatus 800 proceeds to S307. On the other hand, if no instruction is received (NO in S306), the process of the data processing apparatus 800 proceeds to S312. In the present embodiment, the instruction to be received via the terminal apparatus 1000 is described as either an instruction related to the control of the robot control device 600 or an instruction related to a change in the settings of the data processing apparatus 800 and connected devices in remote monitoring. Examples of the instruction to be transmitted to the robot control device 600 include an instruction related to the control of the welding robot 100, and an instruction related to the control of the welding power supply 400.

In S307, the data processing apparatus 800 determines whether the received instruction is an instruction related to the control of the robot control device 600. If the received instruction is an instruction related to the control of the robot control device 600 (YES in S307), the process of the data processing apparatus 800 proceeds to S308. On the other hand, if the received instruction is not an instruction related to the control of the robot control device 600 (NO in S307), the process of the data processing apparatus 800 proceeds to S310.

In S308, the data processing apparatus 800 generates a control command for the robot control device 600 in accordance with the received instruction.

In S309, the data processing apparatus 800 transmits the control command generated in S308 to the robot control device 600. The robot control device 600 controls the welding robot 100 or the welding power supply 400 in accordance with the control command from the data processing apparatus 800. Thereafter, the process of the data processing apparatus 800 proceeds to S312.

In S310, the data processing apparatus 800 changes the settings of the data processing apparatus 800 and the connected devices in accordance with the received instruction. The connected devices include, for example, the robot control device 600, the image capturing device 700, and the welding power supply 400. The change in the settings may be, for example, a change in the image-capturing conditions of the image capturing device 700 or the parameters of the streaming data, or may be an addition of information to be displayed on a UI screen described below. At this time, if further extraction of feature points is required in response to the change in the settings, processing similar to that of S303 may be performed.

In S311, the data processing apparatus 800 transmits data based on the settings changed in S310 to the terminal apparatus 1000. At this time, the number of items of data to be transmitted may be increased or decreased according to the change made in S310. Then, the process of the data processing apparatus 800 proceeds to S312.

In S312, the data processing apparatus 800 determines whether to terminate the remote monitoring. The remote monitoring may be terminated in accordance with an instruction from the terminal apparatus 1000 or an instruction from an administrator of the data processing apparatus 800. Alternatively, the remote monitoring may be terminated in response to detection of the completion of the welding started in S302. Even after the remote monitoring is terminated, the welding itself may be continued. If the remote monitoring is to be terminated (YES in S312), the process flow ends. If the remote monitoring is not to be terminated (NO in S312), the process of the data processing apparatus 800 returns to S303, and the process is repeated.

### Remote Monitoring Process in Terminal Apparatus

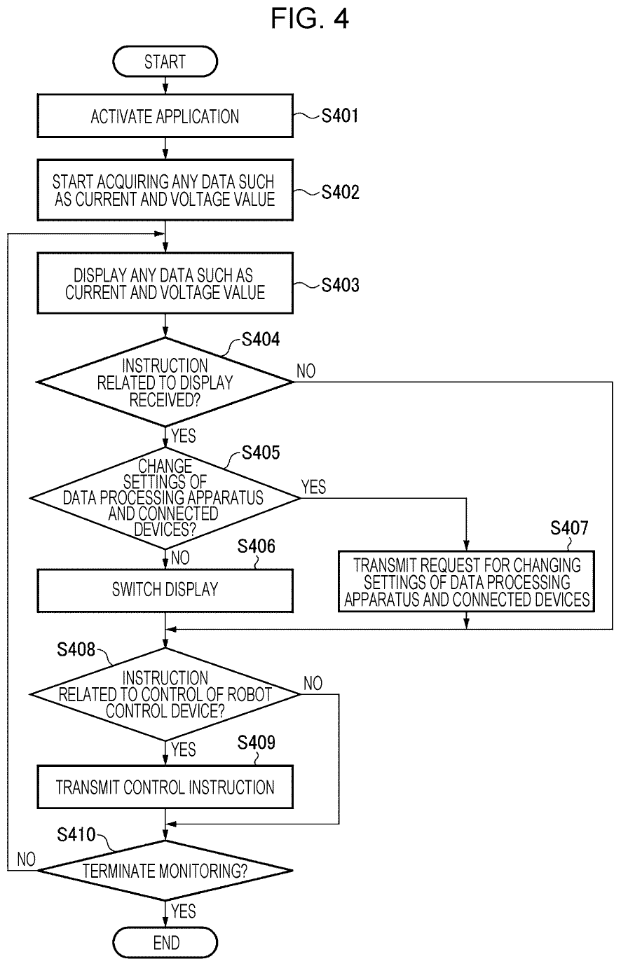

FIG. 4 is a flowchart of a remote monitoring process performed by the terminal apparatus 1000 according to the present embodiment. The illustrated process flow may be implemented by a processing unit (not illustrated) of the terminal apparatus 1000 reading and executing the remote monitoring application 1001 stored in a storage unit (not illustrated). For ease of description, the process flow will be described as being collectively performed by the terminal apparatus 1000. The terminal apparatus 1000 is capable of transmitting and receiving data to and from the welding system 50 via the network 1100.

In S401, the terminal apparatus 1000 activates the remote monitoring application 1001 and starts remote monitoring of the welding system 50. At this point in time, the remote monitoring process on the data processing apparatus 800 illustrated in FIG. 3 has been started.

In S402, the terminal apparatus 1000 starts acquiring streaming data that is being streamed by the data processing apparatus 800. The terminal apparatus 1000 may also start acquiring any data other than the streaming data from the connected devices. In the present embodiment, the terminal apparatus 1000 acquires, in addition to the streaming data, data such as the current, the voltage value, and the welding speed from the robot control device 600. The above data may be acquired in temporal association with the streaming data.

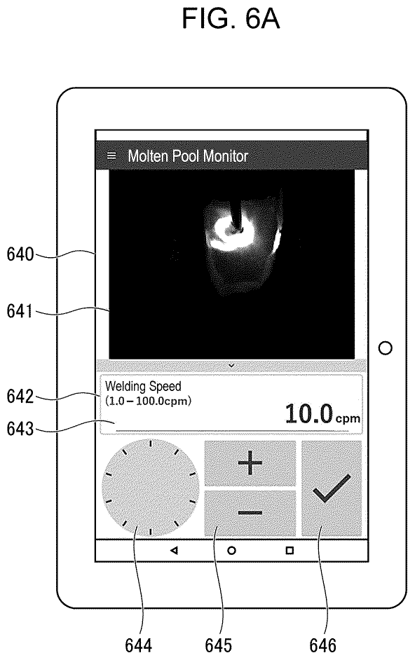

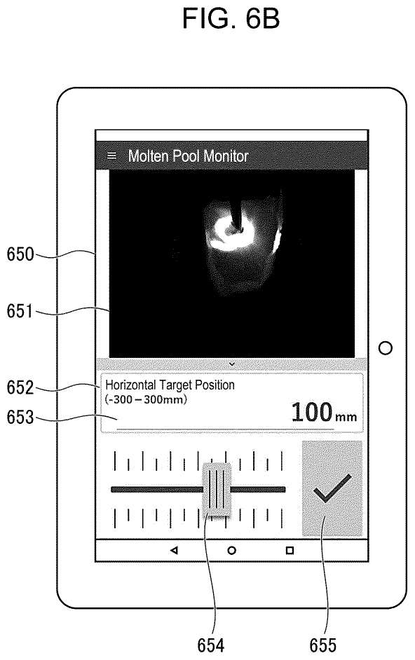

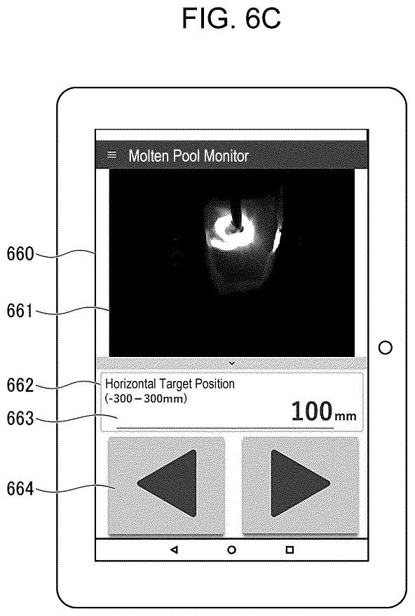

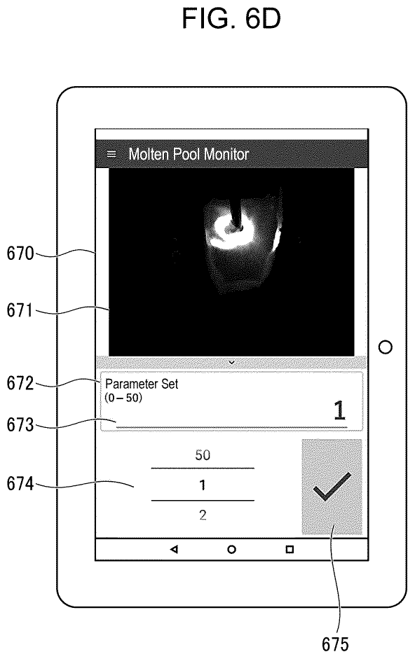

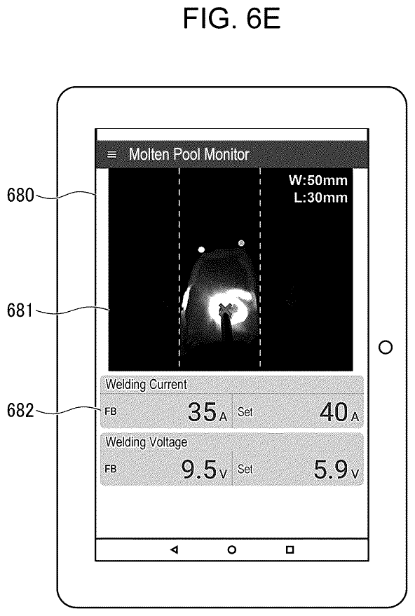

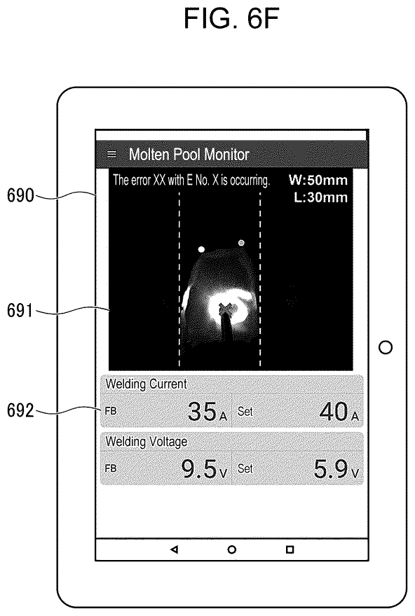

In S403, the terminal apparatus 1000 displays the acquired streaming data on a display unit (not illustrated). Display examples will be described below. As illustrated in FIGS. 6A to 6F, which will be described below, any acquired data may be displayed on the display unit (not illustrated). In the present embodiment, data such as the current, the voltage value, and the welding speed is displayed. In the present embodiment, the remote monitoring application 1001 of the terminal apparatus 1000 holds layout information for configuring the UI screen, and appropriately arranges and displays the streaming data and other data such as the current value acquired from the data processing apparatus 800 or the like on the UI screen. The layout information may be adjustable as desired by the user of the terminal apparatus 1000.

In S404, the terminal apparatus 1000 determines whether an instruction related to display is received from the user. Examples of the instruction related to display include screen switching, addition of a display item, and deletion of a display item. Such an instruction may be performed through, for example, an operation such as tapping, double tapping, long pressing, pinching, or flicking on a touch panel display (not illustrated) included in the terminal apparatus 1000. If an instruction related to display is received (YES in S404), the process of the terminal apparatus 1000 proceeds to S405. If an instruction related to display is not received (NO in S404), the process of the terminal apparatus 1000 proceeds to S408.

In S405, the terminal apparatus 1000 determines whether the settings of the data processing apparatus 800 and the connected devices are to be changed in accordance with the instruction related to display. The settings of the data processing apparatus 800 and the connected devices are to be changed when, for example, additional information to be displayed is to be acquired in response to the instruction related to display. If the settings of the data processing apparatus 800 and the connected devices are to be changed (YES in S405), the process of the terminal apparatus 1000 proceeds to S407. On the other hand, if the settings of the data processing apparatus 800 and the connected devices are not to be changed (NO in S405), the process of the terminal apparatus 1000 proceeds to S406.

In S406, the terminal apparatus 1000 switches the display in accordance with the instruction related to display. An example of switching of the display will be described below. Then, the process of the terminal apparatus 1000 proceeds to S408.

In S407, the terminal apparatus 1000 requests the data processing apparatus 800 to change the settings of the data processing apparatus 800 and the connected devices in accordance with the instruction related to display. Then, in response to the request, the terminal apparatus 1000 acquires data of the data processing apparatus 800 and the connected devices after the settings are changed, and switches the display. Thereafter, the process of the terminal apparatus 1000 proceeds to S408.

In S408, the terminal apparatus 1000 determines whether an instruction related to the control of the robot control device 600 is received from the user. Examples of the instruction related to the control of the robot control device 600 include a change of the welding current, an adjustment of a target position, and a change of a welding parameter set. The examples of the instruction will be described below together with UI screens. If an instruction related to the control of the robot control device 600 is received (YES in S408), the process of the terminal apparatus 1000 proceeds to S409. If an instruction related to the control of the robot control device 600 is not received (NO in S408), the process of the terminal apparatus 1000 proceeds to S410.

In S409, the terminal apparatus 1000 generates a control instruction based on the instruction related to the control of the robot control device 600, and transmits the control instruction to the data processing apparatus 800. Then, the process of the terminal apparatus 1000 proceeds to S410.

In S410, the terminal apparatus 1000 determines whether to terminate the remote monitoring. The remote monitoring may be terminated in accordance with an instruction from the data processing apparatus 800 or an instruction from the user of the terminal apparatus 1000. If the remote monitoring is to be terminated (YES in S410), the process flow ends. If the remote monitoring is not to be terminated (NO in S410), the process of the terminal apparatus 1000 returns to S403, and the process is repeated.

### Examples of Remote Monitoring Screen

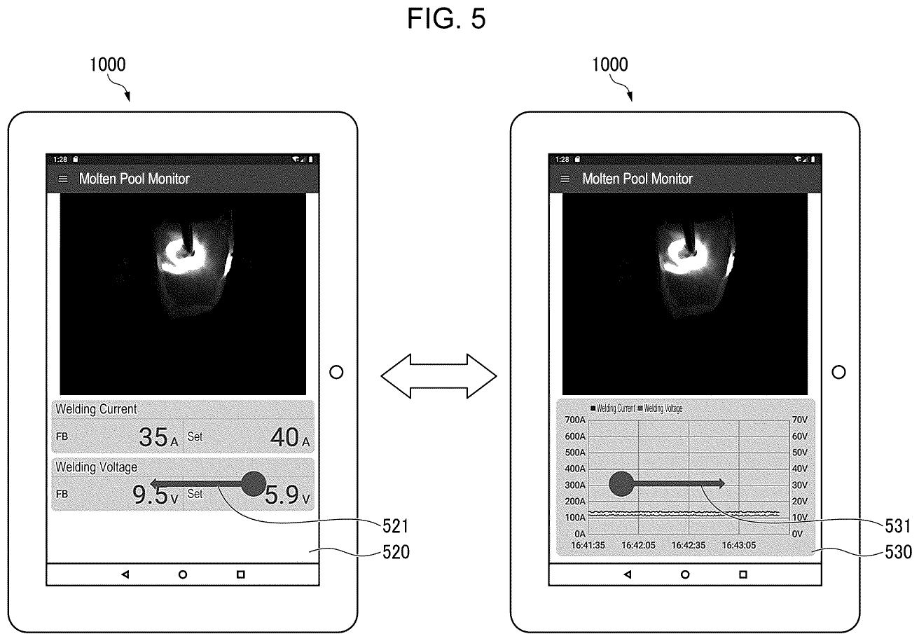

Example configurations of remote monitoring screens serving as UI screens to be displayed on the terminal apparatus 1000 will be described with reference to FIG. 5 and FIGS. 6A to 6F. Each remote monitoring screen is generated by the remote monitoring application 1001 collecting various types of information, and is provided from the remote monitoring application 1001 via the display unit (not illustrated) of the terminal apparatus 1000.

FIG. 5 is a diagram illustrating switching between remote monitoring screens on the terminal apparatus 1000. A remote monitoring screen 520 displays, in real time, streaming data during welding, a set value and a measured value of the welding current, and a set value and a measured value of the welding voltage. In response to a flick operation 521 on the remote monitoring screen 520, the remote monitoring screen 520 is switched to a remote monitoring screen 530. On the remote monitoring screen 530, the welding voltage and the welding current are depicted in a graph. In response to a flick operation 531 on the remote monitoring screen 530, the remote monitoring screen 530 can be switched to the remote monitoring screen 520. While a flick has been described as an example of a switching operation, the switching operation is not limited to a flick and may be performed in any other way. In addition, the items to be displayed may be switched according to the attitude, the orientation, or the like of the terminal apparatus 1000.

A remote monitoring screen 640 illustrated in FIG. 6A includes streaming data 641 and a setting item 642 for the welding speed. The setting item 642 includes a currently set value 643, a rotary dial 644 for specifying a set value, an increase/decrease button 645, and a confirm button 646. On the remote monitoring screen 640, the welding speed can be specified in the range of a lower limit of 1.0 cpm to an upper limit of 100.0 cpm by tapping the increase/decrease button 645 for increase (+) or decrease (−). In addition to the increase/decrease button 645, the rotary dial 644 can be rotated to specify a control parameter. After the control parameter is specified, the confirm button 646 is selected to perform an operation related to welding.

A remote monitoring screen 650 illustrated in FIG. 6B includes streaming data 651 and a setting item 652 for the horizontal target position of the torch 200. The setting item 652 includes a currently set value 653, a scroll bar 654 for specifying a set value, and a confirm button 655. On the remote monitoring screen 650, the scroll bar 654 can be operated to specify the horizontal target position of the torch 200 in the range of −300 mm to 300 mm with respect to the welding direction, that is, the direction of travel of the torch 200. The scroll bar 654 can be operated by sliding it. After the set value is specified, the confirm button 655 is selected to perform an operation related to welding.

A remote monitoring screen 660 illustrated in FIG. 6C includes streaming data 661 and a setting item 662 for the horizontal target position of the torch 200. The setting item 662 includes a currently set value 663 and set buttons 664 for specifying a set value. On the remote monitoring screen 660, the set buttons 664 can be operated to specify the horizontal target position of the torch 200 in the range of −300 mm to 300 mm with respect to the welding direction, that is, the direction of travel of the torch 200. The set buttons 664 can be operated by tapping them.

A remote monitoring screen 670 illustrated in FIG. 6D includes streaming data 671 and a setting item 672 for selecting a parameter set that is set in advance for the welding operation of the welding robot 100. The setting item 672 includes a currently set value 673, a number picker 674 for specifying a set value, and a confirm button 675. On the remote monitoring screen 670, a desired parameter set can be specified by selection from a list of multiple parameter sets defined in advance. The list is presented using the number picker 674, and the number picker 674 can be operated by spinning it by swiping. After the parameter set is specified, the confirm button 675 is selected to perform an operation related to welding.

A remote monitoring screen 680 illustrated in FIG. 6E includes streaming data 681 and a control parameter 682 of a set value and a measured value for welding. In this example, the welding current and the welding voltage are indicated as control parameters related to welding. In the streaming data 681, information such as the width of the molten pool identified from the feature is displayed in a superimposed manner. In the streaming data 681 of this example, the positions of both ends of the tip of the molten pool (circles in the streaming data 681), the width of the molten pool (dotted lines in the streaming data 681), and the position of the wire tip (a cross mark in the streaming data 681) are combined as feature points. In addition, a width W and a length L of the molten pool derived from the coordinate data of the feature points are displayed in a combined manner with the image data. In the present embodiment, the width W and the length L of the molten pool are calculated by the control signal calculation unit 606 based on the coordinate data of the feature points.

A remote monitoring screen 690 illustrated in FIG. 6F has a configuration similar to that in FIG. 6E, and depicts a state in which an abnormality is detected. In this example, when an abnormality (with the error number “E No. X”) is detected, a message indicating “The error XX with E No. X is occurring” is displayed in streaming data 691 in a combined manner. As in the screen configuration illustrated in FIG. 6E, a control parameter 692 includes a set value and a measured value for welding.

The user can use the remote monitoring screens 640 to 690 as illustrated in FIGS. 6A to 6F displayed on the terminal apparatus 1000 to grasp the welding status in real time and easily perform an operation according to the welding status. The configurations of the remote monitoring screens 640 to 690 and the items to be displayed on the remote monitoring screens 640 to 690 are examples and are not limited to these. For example, the user may be allowed to customize which setting items are to be displayed among the setting items illustrated in FIGS. 6A to 6F. In addition, instead of a configuration in which one remote monitoring screen displays a single setting item, one remote monitoring screen may display multiple setting items.

Operation items for various operations to be displayed on a remote monitoring screen are not limited to those described above. For example, operation items of various types such as a cross key and text input may be included. Such operation items may be provided in consideration of operations using a touch panel display included in the terminal apparatus 1000, or may be configured assuming a physical user interface (such as buttons and an operation bar) included in the terminal apparatus 1000.

As described above, the present embodiment makes it possible to reduce delays in the acquisition and presentation of monitoring information by a terminal apparatus, and enables easy remote control according to the status of a monitoring target. In particular, in a welding system, it is possible to easily provide an instruction for control related to welding even remotely while improving real-time monitoring. Accordingly, the convenience of the welding system can be improved for the user.

### Other Embodiments

The present invention can also be implemented by a process in which a program or an application for implementing one or more functions in the embodiment described above is supplied to a system or an apparatus via a network, a storage medium, or the like and one or more processors in a computer of the system or the apparatus reads and executes the program.

The present invention may be implemented by a circuit that implements one or more functions. Examples of the circuit that implements one or more functions include an application specific integrated circuit (ASIC) and a field programmable gate array (FPGA).

As described above, the following features are disclosed herein.
(1) A remote monitoring system includes:
a robot (e.g., the welding robot 100);
an image capturing device (e.g., the image capturing device 700) configured to perform image capture of an operating area of the robot;
a power supply (e.g., the welding power supply 400) configured to control an output of a current or a voltage;
a data processing apparatus (e.g., the data processing apparatus 800) configured to process data related to an operation of the robot or the power supply; and
a terminal apparatus (e.g., the terminal apparatus 1000) configured to communicate with the data processing apparatus via a network (e.g., the network 1100), in which
the data processing apparatus includes:
   a generation unit (e.g., the information generation unit 814) configured to generate streaming data by using image data captured by the image capturing device;
   a distribution unit (e.g., the streaming distribution unit 817) configured to distribute the streaming data; and
   a robot command unit (e.g., the robot command unit 816) configured to issue at least one of an operation instruction to the robot or an operation instruction to the power supply in accordance with at least an instruction from the terminal apparatus, and
the terminal apparatus includes:
   a display control unit (e.g., the remote monitoring application 1001) configured to receive the streaming data distributed from the data processing apparatus and display the streaming data on a monitoring screen (e.g., the remote monitoring screen 640); and
   an instruction receiving unit (e.g., the remote monitoring application 1001) configured to receive an instruction for the robot or the power supply on the monitoring screen and transmit the instruction to the data processing apparatus.

This configuration makes it possible to reduce delays in the acquisition and presentation of monitoring information by the terminal apparatus, and enables easy remote control according to the status of the monitoring target.
(2) The remote monitoring system according to (1), in which
the data processing apparatus further includes a derivation unit configured to derive a feature in the image data, and
the generation unit is configured to generate the streaming data by using the image data and the feature in the image data.

This configuration enables remote monitoring of the state of the robot based on the feature obtained from the image data.
(3) The remote monitoring system according to (2), in which the derivation unit is configured to derive the feature in the image data by using a trained model that receives image data as an input and outputs a feature included in the image data, the trained model being generated through a learning process.

This configuration enables derivation of the feature from the image data using the trained model and enables remote monitoring of the state of the robot based on the feature. (4) The remote monitoring system according to (2) or (3), in which
the data processing apparatus further includes a detection unit (e.g., the abnormality detection unit 813) configured to detect an abnormality related to the operation of the robot by using the feature derived by the derivation unit, and
the generation unit is configured to generate the streaming data by further using information on the abnormality detected by the detection unit.

This configuration enables detection of an abnormality in the robot based on the feature obtained from the image data and enables the detection result to be easily referred to remotely.
(5) The remote monitoring system according to (4), in which the robot command unit is configured to issue an operation instruction to the robot or the power supply, based on the information on the abnormality detected by the detection unit.

This configuration enables easy control of the robot or the power supply based on an abnormality in the robot that is identified based on the feature obtained from the image data.
(6) The remote monitoring system according to any one of (1) to (5), in which the monitoring screen includes at least one of a display item (e.g., the streaming data 641) for displaying the streaming data or an operation item (e.g., the setting item 642) for receiving an operation for the robot or the power supply.

This configuration enables remote instruction of the operation of the robot or the power supply while referring to streaming data distributed in real time.
(7) The remote monitoring system according to any one of (1) to (6), in which the monitoring screen includes display items that are switchable in response to a user operation.

This configuration allows a user to easily monitor and instruct the robot and the power supply remotely while switching to any display item on the monitoring screen.
(8) The remote monitoring system according to (6), in which the streaming data displayed in the display item includes any one of the image data captured by the image capturing device, composite image data including the image data and a feature in the image data, error information, and operation information of the robot.

This configuration allows the user to refer to streaming data including various kinds of image data on the monitoring screen.
(9) The remote monitoring system according to (6), in which the operation item includes any one of a cross key, a button, a number picker, and a scroll bar.

This configuration makes it possible to configure the monitoring screen that includes an operation item for improving operability for the user.
(10) The remote monitoring system according to any one of (1) to (9), in which the robot is a welding robot (e.g., the welding robot 100) and the power supply is a welding power supply.

This configuration makes it possible to, in a welding system, easily provide an instruction for control related to welding even remotely while improving real-time monitoring. Accordingly, the convenience of the welding system can be improved for the user.
(11) A remote monitoring method for a system, the system including a robot (e.g., the welding robot 100), an image capturing device (e.g., the image capturing device 700) that performs image capture of an operating area of the robot, a power supply (e.g., the welding power supply 400) that controls an output of a current or a voltage, a data processing apparatus (e.g., the data processing apparatus 800) that processes data related to an operation of the robot or the power supply, and a terminal apparatus (e.g., the terminal apparatus 1000) that communicates with the data processing apparatus via a network (e.g., the network 1100), the remote monitoring method including:
a generation step (e.g., S304) of, by the data processing apparatus, generating streaming data by using image data captured by the image capturing device;
a distribution step (e.g., S305) of, by the data processing apparatus, distributing the streaming data;
a robot command step (e.g., S308, S309) of, by the data processing apparatus, issuing at least one of an operation instruction to the robot or an operation instruction to the power supply in accordance with at least an instruction from the terminal apparatus;
a display control step (e.g., S402, S403) of, by the terminal apparatus, receiving the streaming data distributed from the data processing apparatus and displaying the streaming data on a monitoring screen; and
an instruction receiving step (e.g., S408, S409) of, by the terminal apparatus, receiving an instruction for the robot or the power supply on the monitoring screen and transmitting the instruction to the data processing apparatus.

This configuration makes it possible to reduce delays in the acquisition and presentation of monitoring information by the terminal apparatus, and enables easy remote control according to the status of the monitoring target.
(12) A data processing apparatus (e.g., the data processing apparatus 800) for processing data related to an operation of a robot (e.g., the welding robot 100) or a power supply (e.g., the welding power supply 400), the data processing apparatus including:
a generation unit (e.g., the information generation unit 814) configured to generate streaming data by using image data of an operating area of the robot, the image data being captured by an image capturing device (e.g., the image capturing device 700);
a distribution unit (e.g., the streaming distribution unit 817) configured to distribute the streaming data to a terminal apparatus (e.g., the terminal apparatus 1000) via a network (e.g., the network 1100); and
a robot command unit (e.g., the robot command unit 816) configured to issue at least one of an operation instruction to the robot or an operation instruction to the power supply in accordance with at least an instruction received from the terminal apparatus via the network.

This configuration makes it possible to reduce delays in the acquisition and presentation of monitoring information by the terminal apparatus, and enables easy remote control according to the status of the monitoring target. Accordingly, the convenience of remote monitoring can be improved for the user.
(13) A terminal apparatus (e.g., the terminal apparatus 1000) for communicating via a network (e.g., the network 1100) with a power supply (e.g., the welding power supply 400) or a data processing apparatus (e.g., the data processing apparatus 800) that processes data related to an operation of a robot (e.g., the welding robot 100), the terminal apparatus including:
a display control unit (e.g., the remote monitoring application 1001) configured to receive streaming data distributed from the data processing apparatus and display the streaming data on a monitoring screen (e.g., the remote monitoring screen 640); and
an instruction receiving unit (e.g., the remote monitoring application 1001) configured to receive an instruction for the robot or the power supply on the monitoring screen and transmit the instruction to the data processing apparatus.

This configuration makes it possible to reduce delays in the acquisition and presentation of monitoring information by the terminal apparatus, and enables easy remote control according to the status of the monitoring target. Accordingly, the convenience of remote monitoring can be improved for the user.
(14) A data processing method for processing data related to an operation of a robot (e.g., the welding robot 100), the data processing method including:
a generation step (e.g., S304) of generating streaming data by using image data of an operating area of the robot, the image data being captured by an image capturing device;
a distribution step (e.g., S305) of distributing the streaming data to a terminal apparatus (e.g., the terminal apparatus 1000) via a network (e.g., the network 1100); and
a robot command step (e.g., S308, S309) of issuing at least one of an operation instruction to the robot or an operation instruction to a power supply in accordance with at least an instruction received from the terminal apparatus via the network.

This configuration makes it possible to reduce delays in the acquisition and presentation of monitoring information by the terminal apparatus, and enables easy remote control according to the status of the monitoring target. Accordingly, the convenience of remote monitoring can be improved for the user.
(15) A method for controlling a terminal apparatus (e.g., the terminal apparatus 1000) that communicates via a network (e.g., the network 1100) with a power supply (e.g., the welding power supply 400) or a data processing apparatus (e.g., the data processing apparatus 800) that processes data related to an operation of a robot (e.g., the welding robot 100), the method including:
a display control step (e.g., S402, S403) of receiving streaming data distributed from the data processing apparatus and displaying the streaming data on a monitoring screen; and
an instruction receiving step (e.g., S408, S409) of receiving an instruction for the robot or the power supply on the monitoring screen and transmitting the instruction to the data processing apparatus.

This configuration makes it possible to reduce delays in the acquisition and presentation of monitoring information by the terminal apparatus, and enables easy remote control according to the status of the monitoring target. Accordingly, the convenience of remote monitoring can be improved for the user.
(16) A program for causing a computer (e.g., the data processing apparatus 800) to implement:
a generation unit (e.g., the information generation unit 814) configured to generate streaming data by using image data of an operating area of a robot (e.g., the welding robot 100), the image data being captured by an image capturing device (e.g., the image capturing device 700);
a distribution unit (e.g., the streaming distribution unit 817) configured to distribute the streaming data to a terminal apparatus (e.g., the terminal apparatus 1000) via a network (e.g., the network 1100); and
a robot command unit (e.g., the robot command unit 816) configured to issue at least one of an operation instruction to the robot or an operation instruction to a power supply (e.g., the welding power supply 400) in accordance with at least an instruction received from the terminal apparatus via the network.

This configuration makes it possible to reduce delays in the acquisition and presentation of monitoring information by the terminal apparatus, and enables easy remote control according to the status of the monitoring target. Accordingly, the convenience of remote monitoring can be improved for the user.
(17) A program for causing a computer (e.g., the terminal apparatus 1000) that communicates via a network (e.g., the network 1100) with a power supply (e.g., the welding power supply 400) or a data processing apparatus (e.g., the data processing apparatus 800) that processes data related to an operation of a robot (e.g., the welding robot 100) to implement:
a display control unit (e.g., the remote monitoring application 1001) configured to receive streaming data distributed from the data processing apparatus and display the streaming data on a monitoring screen (e.g., the remote monitoring screen 640); and
an instruction receiving unit (e.g., the remote monitoring application 1001) configured to receive an instruction for the robot or the power supply on the monitoring screen and transmit the instruction to the data processing apparatus.

This configuration makes it possible to reduce delays in the acquisition and presentation of monitoring information by the terminal apparatus, and enables easy remote control according to the status of the monitoring target. Accordingly, the convenience of remote monitoring can be improved for the user.

What is claimed is:

1. A remote monitoring system comprising:
a robot;
an image capturing device configured to perform image capture of an operating area of the robot;
a power supply configured to control an output of a current or a voltage;
a data processing apparatus configured to process data related to an operation of the robot or the power supply; and
a terminal apparatus configured to communicate with the data processing apparatus via a network, wherein
the data processing apparatus includes:
a generation unit configured to generate streaming data by using image data captured by the image capturing device;
a distribution unit configured to distribute the streaming data; and
a robot command unit configured to issue at least one of an operation instruction to the robot or an operation instruction to the power supply in accordance with at least an instruction from the terminal apparatus, and
the terminal apparatus includes:
a display control unit configured to receive the streaming data distributed from the data processing apparatus and display the streaming data on a monitoring screen; and
an instruction receiving unit configured to receive an instruction for the robot or the power supply on the monitoring screen and transmit the instruction to the data processing apparatus.

2. The remote monitoring system according to claim 1, wherein
the data processing apparatus further includes a derivation unit configured to derive a feature in the image data, and
the generation unit is configured to generate the streaming data by using the image data and the feature in the image data.

3. The remote monitoring system according to claim 2, wherein the derivation unit is configured to derive the feature in the image data by using a trained model that receives image data as an input and outputs a feature included in the image data, the trained model being generated through a learning process.

4. The remote monitoring system according to claim 2, wherein
the data processing apparatus further includes a detection unit configured to detect an abnormality related to the operation of the robot by using the feature derived by the derivation unit, and
the generation unit is configured to generate the streaming data by further using information on the abnormality detected by the detection unit.

5. The remote monitoring system according to claim 4, wherein the robot command unit is configured to issue an operation instruction to the robot or the power supply, based on the information on the abnormality detected by the detection unit.

6. The remote monitoring system according to claim 1, wherein the monitoring screen includes at least one of a display item for displaying the streaming data or an operation item for receiving an operation for the robot or the power supply.

7. The remote monitoring system according to claim 1, wherein the monitoring screen includes display items that are switchable in response to a user operation.

8. The remote monitoring system according to claim 6, wherein the streaming data displayed in the display item includes any one of the image data captured by the image capturing device, composite image data including the image data and a feature in the image data, error information, and operation information of the robot.

9. The remote monitoring system according to claim 6, wherein the operation item includes any one of a cross key, a button, a number picker, and a scroll bar.

10. The remote monitoring system according to claim 1, wherein
the robot is a welding robot, and
the power supply is a welding power supply.

11. A remote monitoring method for a system, the system including a robot, an image capturing device that performs image capture of an operating area of the robot, a power supply that controls an output of a current or a voltage, a data processing apparatus that processes data related to an operation of the robot or the power supply, and a terminal apparatus that communicates with the data processing apparatus via a network, the remote monitoring method comprising:
a generation step of, by the data processing apparatus, generating streaming data by using image data captured by the image capturing device;
a distribution step of, by the data processing apparatus, distributing the streaming data;
a robot command step of, by the data processing apparatus, issuing at least one of an operation instruction to the robot or an operation instruction to the power supply in accordance with at least an instruction from the terminal apparatus;
a display control step of, by the terminal apparatus, receiving the streaming data distributed from the data processing apparatus and displaying the streaming data on a monitoring screen; and
an instruction receiving step of, by the terminal apparatus, receiving an instruction for the robot or the power supply on the monitoring screen and transmitting the instruction to the data processing apparatus.

12. A data processing apparatus for processing data related to an operation of a robot or a power supply, the data processing apparatus comprising:
a generation unit configured to generate streaming data by using image data of an operating area of the robot, the image data being captured by an image capturing device;
a distribution unit configured to distribute the streaming data to a terminal apparatus via a network; and
a robot command unit configured to issue at least one of an operation instruction to the robot or an operation instruction to the power supply in accordance with at least an instruction received from the terminal apparatus via the network.

13. A terminal apparatus for communicating via a network with a power supply or a data processing apparatus that processes data related to an operation of a robot, the terminal apparatus comprising:
a display control unit configured to receive streaming data distributed from the data processing apparatus and display the streaming data on a monitoring screen; and
an instruction receiving unit configured to receive an instruction for the robot or the power supply on the monitoring screen and transmit the instruction to the data processing apparatus.

14. A data processing method for processing data related to an operation of a robot, the data processing method comprising:
a generation step of generating streaming data by using image data of an operating area of the robot, the image data being captured by an image capturing device;
a distribution step of distributing the streaming data to a terminal apparatus via a network; and
a robot command step of issuing at least one of an operation instruction to the robot or an operation instruction to a power supply in accordance with at least an instruction received from the terminal apparatus via the network.

15. A method for controlling a terminal apparatus that communicates via a network with a power supply or a data processing apparatus that processes data related to an operation of a robot, the method comprising:
a display control step of receiving streaming data distributed from the data processing apparatus and displaying the streaming data on a monitoring screen; and
an instruction receiving step of receiving an instruction for the robot or the power supply on the monitoring screen and transmitting the instruction to the data processing apparatus.

16. A program for causing a computer to implement:
a generation unit configured to generate streaming data by using image data of an operating area of a robot, the image data being captured by an image capturing device;
a distribution unit configured to distribute the streaming data to a terminal apparatus via a network; and
a robot command unit configured to issue at least one of an operation instruction to the robot or an operation instruction to a power supply in accordance with at least an instruction received from the terminal apparatus via the network.

17. A program for causing a computer that communicates via a network with a power supply or a data processing apparatus that processes data related to an operation of a robot to implement:
a display control unit configured to receive streaming data distributed from the data processing apparatus and display the streaming data on a monitoring screen; and
an instruction receiving unit configured to receive an instruction for the robot or the power supply on the monitoring screen and transmit the instruction to the data processing apparatus.
